(19) United States
(12) Patent Application Publication
(10) Pub. No.: US 2019/0071836 A1
(43) Pub. Date: Mar. 7, 2019

(54) ARTICULATING SYSTEM FOR DRIVING HELICAL PIERS AND ANCHORS

(71) Applicant: Pro-Dig GI, LLC, Elwood, KS (US)

(72) Inventor: CHRISTOPHER P. GILLIBRAND, Saint Louis, MO (US)

(21) Appl. No.: 15/909,356

(22) Filed: Mar. 1, 2018

Related U.S. Application Data
(60) Provisional application No. 62/467,179, filed on Mar. 5, 2017.

(51) Int. Cl. E02D 7/14; F16D 1/12; E02D 13/00

(52) U.S. Cl. CPC E02D 7/14; E02D 7/22; E02D 13/00; F16D 1/12

(57) ABSTRACT

An articulating system for the installation of helical anchors or similar items with a knuckle joint, a sliding collar or sleeve and a guide member. Sliding collar or sleeve includes an inclined slot in which guide member is received. Sliding collar or sleeve may be rotated around guide member and with respect to the knuckle joint such that sliding collar or sleeve moves between knuckle joint free to rotate position and knuckle joint locking when helical anchors or similar items are lifted into vertical position applying a tensile force and straightening the joint.

### BACKGROUND OF THE INVENTION

### Field of the Invention

This invention relates to a system for the installation of helical anchors or similar items. More particularly the invention relates to a system that allows the drive tool to be angled separately from the motive power source to allow the connection of the anchor or pier in a horizontal or near horizontal attitude.

### Brief Description of the Prior Art

A helical anchor/pile is an extendable deep foundation system with helical bearing plates welded to a central steel shaft. Load is transferred from the shaft to the soil through these bearing plates. Segments or sections are joined with bolted couplings. Installation depth is limited only by soil density and practicality based on economics. A helical bearing plate or helix is one pitch of a screw thread. Being a true helical shape, the helices do not auger into the soil but rather screw into it with minimal soil disturbance. Helical plates are spaced at distances far enough apart that they function independently as individual bearing elements; consequently, the capacity of a helix on a helical anchor/pile shaft is not influenced by the helix above or below it.

The helical anchor/pile is attached to the motive power source (typically referred to as an auger drive) via a drive tool, typically by means of a hollow drive tool that is pinned to the upper end of the anchor section being installed. In order to effect the pinned joint there are two main methods, namely:

1) A hole is drilled in the ground and the anchor inserted in to the ground such that the auger drive can be placed over the anchor at a level relative to the ground where it is possible to insert the pins to effect the connection. This requires additional handling equipment in order to pick and place the anchor in the hole. This double handling is also time consuming and any additional handling represents a safety concern.

2) The auger drive is laid down on to the ground in a horizontal aspect such that the auger section can be offered up to the drive tool and pinned. The system is then raised up into the air in order to continue installation. By virtue of the length of the pile and that the system is now rigidly fixed, this can place large side forces on the shaft of the auger drive system. In addition the action of laying the auger drive down on the ground is time consuming and presents handling issues to avoid damage to hoses etc.

### BRIEF SUMMARY OF THE INVENTION

The present invention employs a novel approach to the connection of the anchor section to the auger drive/drive tool. Particularly, the present invention employs a pivoting section that allows the pin-up section of the drive tool to be swung to a horizontal position independently of the auger drive.

Furthermore, once the anchor has been attached to the drive tool the anchor can be raised from the ground where it will assume a vertical position and in doing so allows the present invention to employ a locking mechanism that prevents the pivoting section from further movement and allows the anchor section to be handled and driven as if with a standard fixed drive tool.

### BRIEF DESCRIPTION OF THE SEVERAL VIEWS OF THE DRAWINGS

In the accompanying drawings, in which one several of various possible embodiments of the invention is illustrated, corresponding reference characters refer to corresponding parts throughout the several views of the drawings in which:

FIG. 1 is an explode view of the articulating system wherein an upper or fixed pivoting drive tool adaptor is attached to an auger drive and a lower drive plate is attached to an anchor or drive tool wherein the lower drive cannot pivot unless lined up with an appropriate slot in a locking collar;

FIG. 2 is a side elevation showing the collar in position that the lower drive cannot pivot; and,

FIG. 3 is a side elevation showing the collar in position that the lower drive can pivot with respect to the upper or fixed pivoting drive tool adapter.

### DETAILED DESCRIPTION OF AT LEAST ONE PREFERRED EMBODIMENT OF THE INVENTION

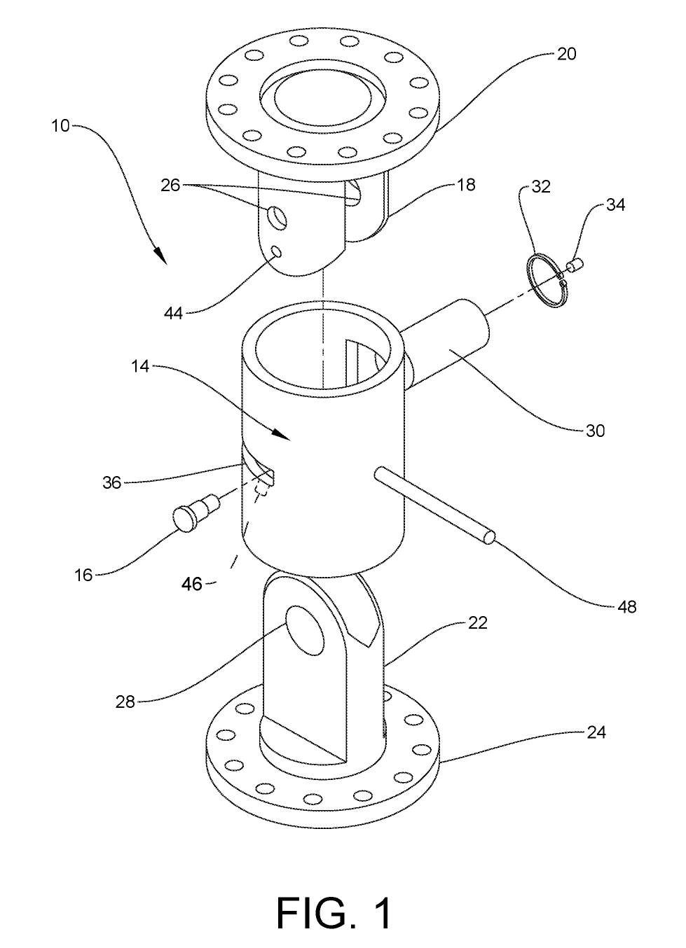

Referring to the drawings more particularly by reference character, reference numeral 10 refers to an articulating system in accordance with the present invention for connecting an auger drive with an anchor or drive tool. In main part, system 10 includes a knuckle joint 12 (FIG. 3), a sliding collar or sleeve 14 and a guide member 16. As seen in FIG. 1, knuckle joint 12 has a forked end 18 attached to a first flange or plate 20 configured for attachment with bolts or the like to an auger drive or anchor or drive tool. An eye end 22 is attached to a second flange or plate 24 configured for attachment to an auger drive or anchor or drive tool. As illustrated in FIG. 1-3, forked end 18 is at the auger drive end and eye end 22 is at the anchor or drive tool end.

Forked end 18 has coaxial holes 26 and eye end 22 has a hole 28 coaxially aligned with the coaxial holes 26 in forked end 18 in an assembled position. A knuckle pin 30 passes through the coaxial holes 26 in forked end 18 and hole 28 in eye end 22 and is held in place with a keeper or collar 32 and locking pin 34 for holding the knuckle joint in the assembled position for sliding fit inside sliding collar or sleeve 14.

Sliding collar or sleeve 14 has an inclined slot 36 angled towards the drive end with an upper end 38 and a lower end 40. Slot 36 is curved and may be arc shaped. Guide member 16 is attached to forked end 18. As illustrated guide member 16 is a guide pin received in a hole 44 provided in forked end 18, just below and coaxially aligned with knuckle pin 30.

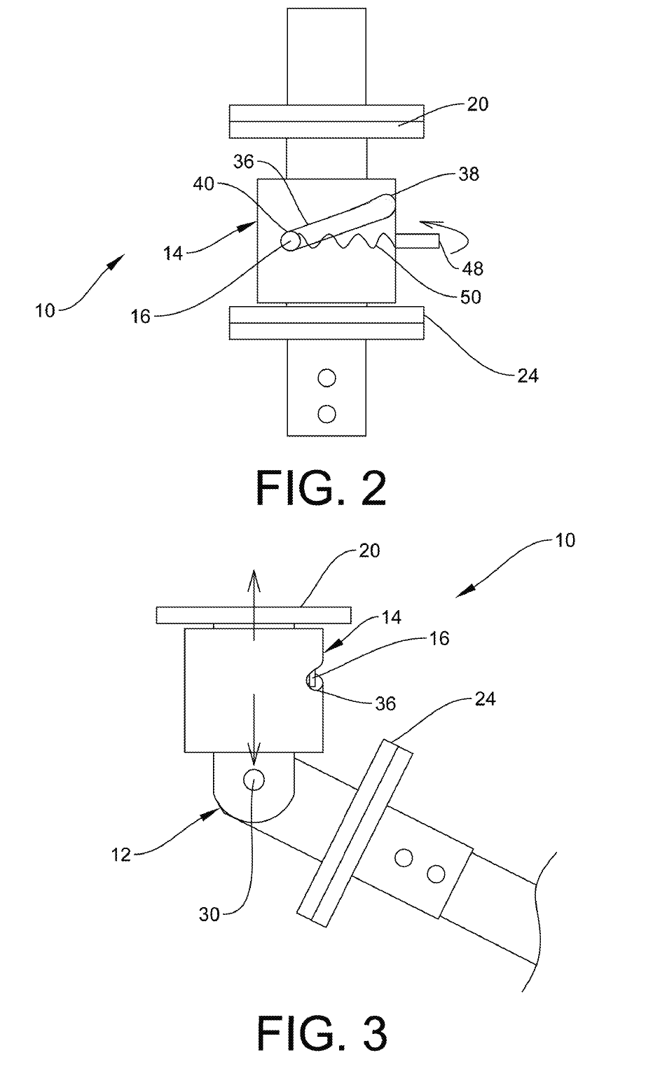

In use, as shown in FIG. 2, guide member 16 is in upper end 40 of slot 36 and a lower end of sliding collar or sleeve 14 is below an axis of knuckle pin 30. A detent 46 (FIG. 1) in slot 36 may be provided for locking guide member 16 in place. Turning to FIG. 3, guide member 16 is in lower end 38 of slot 36 and the lower end of sliding collar or sleeve 14 is above the axis of knuckle pin 30. As shown in FIG. 3, eye end 22 may rotate with respect to forked end 18. When articulating assembly 10 is swung into vertical position as for example with a section of anchor or drive tool attached, the tensile load on the system causes forked end 18 and eye end 22 to align and sliding collar or sleeve 14 may drop down over the joint under force of gravity.

The above locking action of sliding collar or sleeve 14 may be further facilitated with a handle 48 attached to a sidewall of collar or sleeve 14 for rotating slot 36 around guide pin 16. Alternatively or additionally a spring return 50 may be provided between handle 48 and guide pin 16 biasing collar or sleeve 14 to rotate such that guide pin 16 is in lower end 40 and the joint in locked condition.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What is claimed:

1. An articulating system for connecting an auger drive with an anchor or drive tool comprising a knuckle joint, a sliding collar and a guide member,
said knuckle joint having
a forked end attached to a first flange configured for attachment to an auger drive or anchor or drive tool;
an eye end attached to a second flange configured for attachment to an auger drive or anchor or drive tool;
said forked end having coaxial holes and said eye end having a hole coaxially aligned with the coaxial holes of the forked end in an assembled position;
a knuckle pin passing through the coaxial holes in the forked end and the hole in the eye end coaxially aligned with the coaxial holes in the forked end, said knuckle pin held in position with a keeper and a locking pin for holding the knuckle joint in the assembled position; and,
said knuckle joint slidingly fit inside the sliding collar;
said sliding collar having a slot angled towards the drive end with an upper end and a lower end,
said guide member attached to the forked end and extending through the slot, said guide member being in the upper end of the slot when the sliding collar is below an axis of the knuckle pin preventing movement of the joint about the axis of the knuckle pin, said guide member being in the lower end of the slot when the sliding collar is lifted above the axis of the knuckle pin and the forked end and eye end are capable of rotating about the axis of the knuckle pin.

2. The articulating system of claim 1 wherein the collar is cylindrical and the slot is arc shaped.

3. The articulating system of claim 1 wherein the guide member is a pin coaxially aligned with the knuckle pin.

4. An articulating system for connecting an auger drive with an anchor or drive tool comprising a knuckle joint, a sliding sleeve, a guide member and a handle,
said knuckle joint having
a forked end attached to a first flange configured for attachment to an auger drive or anchor or drive tool;
an eye end attached to a second flange configured for attachment to an auger drive or anchor or drive tool;
said forked end having coaxial holes and said eye end having a hole coaxially aligned with the coaxial holes of the forked end in an assembled position;
a knuckle pin passing through the coaxial holes in the forked end and the hole in the eye end coaxially aligned with the coaxial holes in the forked end, said knuckle pin held in position with a collar and a locking pin for holding the knuckle joint in the assembled position;
said knuckle joint slidingly fit inside the sliding sleeve;
said sliding sleeve having a slot angled towards the drive end with an upper end and a lower end,
said guide member attached to the forked end and extending through the slot, said guide member being in the upper end of the slot when the sliding sleeve is below an axis of the knuckle pin preventing movement of the joint about the axis of the knuckle pin, said guide member being in the lower end of the slot when the sliding sleeve is lifted above the axis of the knuckle pin and the forked end and eye end are capable of rotating about the axis of the knuckle pin; and,
said handle attached to a sidewall of the sliding sleeve for rotation of the sleeve around the guide member in the slot.

5. The articulating system of claim 4 wherein the sleeve is cylindrical and the slot is arc shaped.

6. The articulating system of claim 4 wherein the guide member is a pin spaced below and coaxially aligned with the knuckle pin.

7. The articulating system of claim 4 wherein there are detents in the slot for holding the guide member in a selected position.

8. The articulating system of 4 wherein the sleeve is cylindrical and the slot is arc shaped and the guide member is a pin spaced below and coaxially aligned with the knuckle pin, said system further having a spring member connected between the handle and the pin for biasing the pin towards the lower end of the slot.
